(19) United States
(12) Patent Application Publication
(10) Pub. No.: US 2007/0282991 A1
(43) Pub. Date: Dec. 6, 2007

(54) Remote song selection

(75) Inventor: Jeffrey J. Kalis, Rockford, MI (US)

Correspondence Address: DICKSTEIN SHAPIRO LLP, 1825 EYE STREET NW, Washington, DC, 20006-5403, US

(73) Assignee: Rowe International Corporation

(21) Appl. No.: 11/444,431

(22) Filed: Jun. 1, 2006

(51) Int. Cl. G06F 15/173

(52) U.S. Cl. 709/223

(57) ABSTRACT

A system and method for remote song selection on any of a plurality of digital jukeboxes. Each of the digital jukeboxes store and play digital music files that may be downloaded from a central music repository. A data center is provided for managing the jukeboxes. The data center receives and processes a song selection request generated by a remote device. The data center transmits a command to the desired jukebox to play the song selection.

### BACKGROUND

For decades, the term jukebox was synonymous with a housing for a phonograph player and a collection of musical recordings stored in the housing as a plurality of records. These jukeboxes were usually large and were mainly located in establishments like bars and restaurants. Eventually, the records in jukeboxes were replaced with compact discs (CDs). Although compact discs increased the sound quality of conventional jukeboxes, routinely updating conventional jukeboxes was a lengthy and cumbersome task.

Updating conventional jukeboxes required a significant investment of time and money. Routemen were required to travel to each jukebox location to replace outdated recordings with up-to-date CDs or records. A new physical copy of each disc was needed for every location and many unneeded copies of the outdated recordings remained after removal from the jukebox. New ways to store and update musical recordings on jukeboxes were needed to eliminate or reduce this laborious and expensive update procedure.

The influx of digital music provided an opportunity to change the design and operation of conventional jukeboxes. As suggested in U.S. Pat. No. 5,355,302, conventional jukeboxes could be replaced with a network of computer jukeboxes capable of storing digital music in memory and updating the music contained on the jukebox over a network connection. Computer jukeboxes reduced the necessity of routemen to update jukeboxes manually. The computer jukeboxes provided many advantages beyond the saved expense in updating. A plurality of jukeboxes could now be controlled via a central management center, allowing centralization of tasks such as royalty accounting. Digital music has become increasingly popular due, in part, to improved compression technology and the greater availability of high-speed internet access. Essentially, any computer system with speakers is a jukebox capable of playing an increasingly larger selection of music and video on-demand.

With most digital jukebox systems, a user must physically be at the jukebox location with a form of payment in-hand in order to select a song. U.S. Patent Publication No. 2004/0243482 refers to creation of a personal selection list that can be used to remotely request songs for play at any of a plurality of jukebox devices located at different locations. Once a user creates a personal play list, the user can access that list by entering identifying information, and select a particular jukebox on which to play a song selected from his or her list. However, creating and accessing a personal play list is time consuming and limits the ability of the user to play individual song tracks, for example.

What is needed is a more flexible system and method for allowing remote song selection on networked jukeboxes.

### BRIEF SUMMARY OF THE INVENTION

In various exemplary embodiments, the invention relates to a system and method for remote song selection on any of a plurality of networked, digital jukeboxes. In one embodiment, each of the networked, digital jukeboxes can store and play digital music files that may be downloaded from a central music repository. A central data center can be provided for managing the jukeboxes. In a preferred embodiment, the central data center receives and processes the remote song selection requests, and transmits a command to the desired jukebox to play the song selection.

One object of the invention is to provide a system and method for selecting songs to play at a digital jukebox from a remote location, either under normal or priority play conditions. A further object of the invention is to provide a central data center for handling such remote requests. Another object of the invention is to provide a means of billing a user who requests a remote song selection, and determining proper royalty calculations for the song when played on the selected jukebox.

In one exemplary embodiment, the invention is directed to a method of remotely selecting a song for play on a computer jukebox comprising: providing a first data center coupled to a network comprising a plurality of computer jukeboxes; establishing a communications link between a remote device and the data center; sending a first message from the remote device to the data center, wherein the first message comprises: a selection of a computer jukebox on which the user of the remote device desires a song to be played and a selection of a song that the user of the remote device desires to be played on the computer jukebox; transmitting a second message from the data center to the selected jukebox wherein the second message comprises a command for the jukebox to play the selected song; and playing the selected song at the selected jukebox in response to receiving the second message.

In another embodiment, the invention is directed to systems for remote selection of a song on a computer jukebox. The system comprises, for example, a first data center comprising at least one server for managing a plurality of jukeboxes; each of the plurality of computer jukeboxes including: a memory for storing a plurality of digital songs; a playback mechanism for playing the plurality of digital songs; and a communication interface for sending and receiving messages from the first data center; and at least one remote device capable of sending messages to the first data center, the messages comprising requests for musical selections for a particular jukebox, and in response to receiving one of said messages, said first data center generates a command for a selected jukebox.

In a preferred embodiment, remote song selection is made through a remote device (e.g., a telephone, a PDA, a personal computer, a Bluetooth device, a digital camera, an MP3 player, and a digital game machine) to select songs for play on a digital jukebox.

### BRIEF DESCRIPTION OF THE DRAWINGS

The foregoing and other aspects of the invention will be better understood from the following detailed description of the invention, which is provided in connection with the accompanying drawings, in which:

FIG. 1A is a block diagram of a part of a jukebox system in accordance with the invention;

FIG. 1B is a block diagram showing other parts of the jukebox system in accordance with the invention;

FIG. 2 is a block diagram of a message structure that can be transmitted to or from a data center in accordance with the present invention; and

FIG. 3 is a flow chart diagram depicting a method of operation of a jukebox system in accordance with the invention.

### DETAILED DESCRIPTION OF THE PREFERRED EMBODIMENTS

In the following detailed description, reference is made to the accompanying drawings, which form a part hereof and show by way of illustration specific embodiments in which the invention may be practiced. These embodiments are described in sufficient detail to enable those skilled in the art to practice the invention, and it is to be understood that other embodiments may be utilized, and that changes to the described embodiments may be made without departing from the spirit and scope of the present invention.

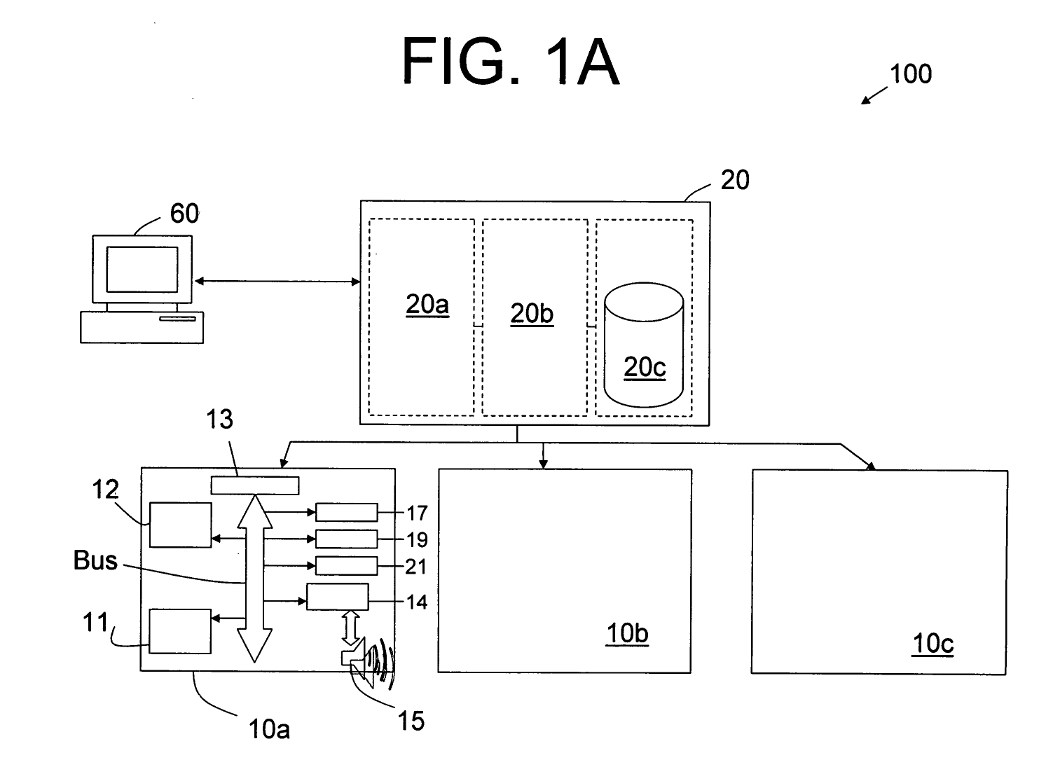

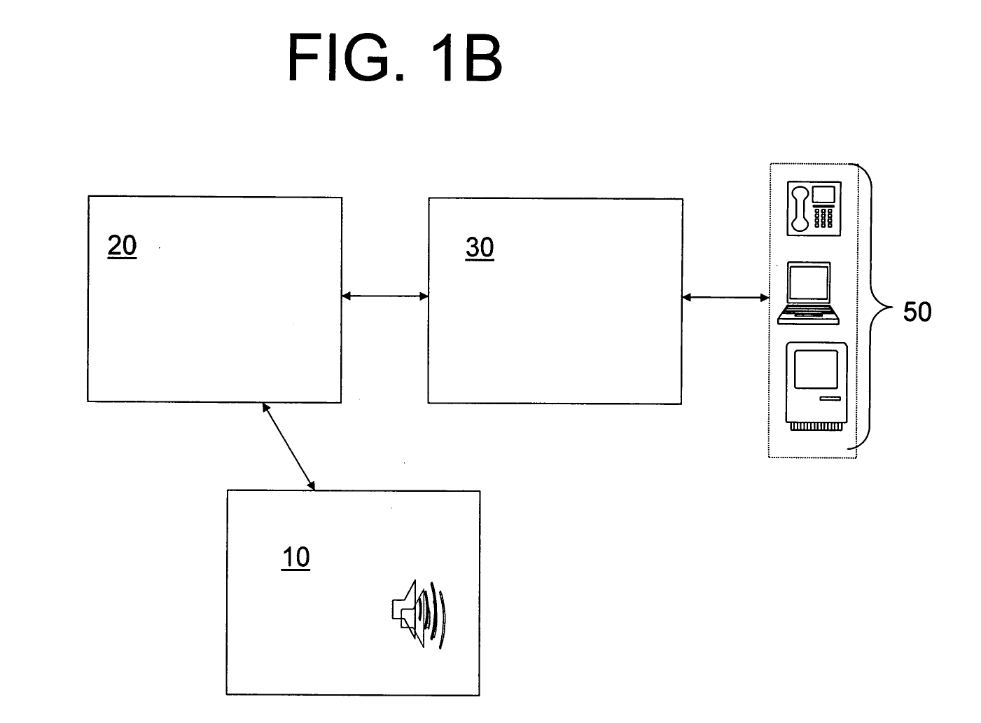

Turning to FIG. 1A, shown is an exemplary portion of a jukebox system 100 according to the invention. The jukebox system 100 includes a plurality of networked jukeboxes 10a, 10b, 10c that are connected to a main data center 20. The data center 20 is preferably a collection of computer servers 20a, 20b, 20c, each of which, it should be understood, may include all necessary computer parts for receiving, sending, and processing information. When a collection of servers 20a, 20b, 20c, are used, each may function to communicate with a respective set of jukeboxes 10a, 10b, 10c, or each server 20a, 20b, 20c may provide particularized functions for the data center 20. For example, one of the servers 20a may be primarily for communicating with the jukeboxes 10a, 10b, 10c. An additional server 20b may be used for storing digital music files that can be downloaded by the individual jukeboxes 10a, 10b, 10c. Another server 20c may be used for storing a database 21 containing information necessary for managing each of the individual jukeboxes 10a, 10b, 10c. This database 20c may also contain information for calculating billing and/or royalty payments. The data center 20 may be one centrally located center, a series of regional data centers, or a combination of centrally located and regional data centers.

Each jukebox 10 includes at least one memory 11 for storing a plurality of digital music files and information relating to the stored musical files. Other forms of music, such as CDs or vinyl albums, may also be used by the jukeboxes 10a, 10b, 10c. The memory may be a hard drive, a collection of hard drives, or any other type of memory capable of storing large quantities of digital music files (e.g., RAM, ROM, DVD-RAM, DVD-R, DVD-RW, CD-R, CD-RW, memory stick, memory cards (CF, SD, XD)).

Each jukebox 10 also has a display 21, which may display graphics, such as album covers, but also displays text such as selection instructions and song titles. The display 21 may be in the form of a touch-screen, such that a user can make his selections by pressing points on the display screen 21. Alternatively, a user may enter selections or otherwise interact with jukebox 10 using a keyboard, mouse (e.g., user input device 19) or any other device capable of inputting information into jukebox 10. The jukeboxes 10 can also have a processor 12, a communication interface 13, and an audio reproduction circuit 14 coupled to at least one speaker 15 for replaying the songs. The audio reproduction circuit 14 may include a song card, a digital-to-analog converter, and means for decompressing compressed, digital files. Other optional parts of the jukeboxes 10 include a money detector 17, such as a coin, bill, and/or credit card acceptor, and a user input device 19, such as a keypad, manual keyboard, mouse, stylus, and other types of selection devices. Money detector 17 can include a device for electronic detection of a source of credit or money (i.e., credit card, device with a barcode or RFID tag).

In accordance with a preferred embodiment of the invention, the jukeboxes 10a, 10b, 10c are capable of receiving commands from the data center 20. Among these commands is a command to play a particular song on the jukebox 10. The song may be either resident locally on the jukebox 10 or may be stored and downloadable from a central memory 20b at the data center 20. The command is based on a request received from a remote device 50 (FIG. 1B). The remote device 50 may be any of a telephone, personal computer, personal digital assistant (PDA), a game machine, MP3 player, digital camera, Bluetooth device, or another jukebox 10. The remote device 50 communicates with the data center 20 as described herein to select a song for play on an individual jukebox.

Exemplary remote devices 50 are depicted in FIG. 1B as being a telephone, a laptop computer, and a PDA. The system 100 may include several types of remote devices 50 that can transmit requests to the data center 20. The remote device 50 may be one of a series of any suitable networked devices that communicate with a second set of central servers 30. For example, in the case where the remote device is a game machine, a plurality of individual game machines may be networked to a central server(s) 30 in the same manner described above for the jukeboxes 10a, 10b, 10c communicating with the central data center 20. Thus, the game machine may communicate with a central server 30 to communicate a request for a song to be played at a jukebox 10 located remotely. In this embodiment, the second central server(s) 30 for the remote devices 50 would then communicate the request to the data center 20 for the jukeboxes 10a, 10b, 10c. The data center 20 and second central server 30 may be connected either directly (i.e., physically), by wireless connection, and/or through the Internet. The invention can be independent of the connection path.

Alternatively, the networked devices 50 may be on the network managed by the first data center 20. In this case, the devices, can communicate directly with the data center 20 to request song selections.

In another embodiment of the invention, system 100 includes a management device 60 for an operator to manage one or more jukeboxes 10a, 10b, etc. The management device 60 may take the form of a personal computer or any other device capable of communicating with the central data center and/or jukebox 10. The device 60 can send management data and/or requests to the central data center 20 which can communicate the management data and/or requests to the particular jukebox 10. The management data and requests may, for example, include new content for the jukebox 10 or may relate to setting operating parameters such as the cost of a play credit. In addition, the operator may use a management device 60 as a remote device 50 for remotely selecting a song to play on a jukebox 10.

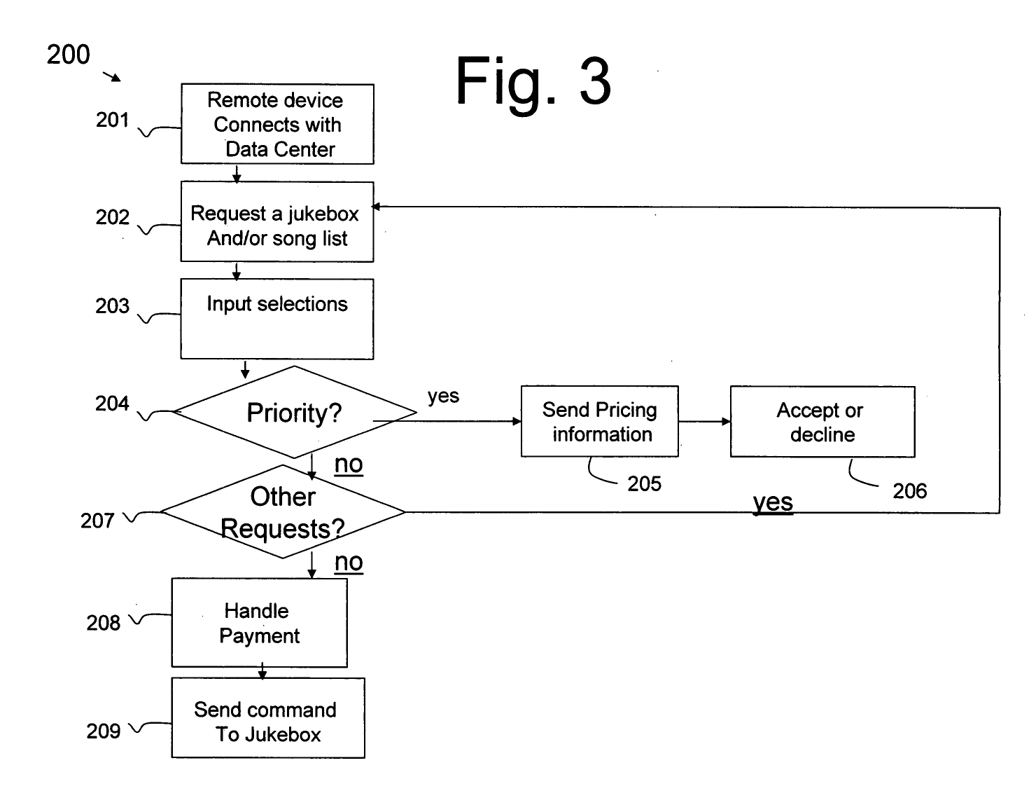

Turning to FIG. 3, an exemplary method 200 of operating the system 100 is now described. At a first step 201, the remote device 50 connects with the data center 20. In accordance with a preferred embodiment, this step 201 can include establishing a connection between the remote device 50 and a second central server 30, which in turn, connects with the data center 20. Once a communication path is created, the remote device 50 can, for example, request a list of the jukeboxes and/or the songs available for play on the individual jukeboxes 10 from data center 20 and/or the second central server, as shown in an optional step 202. In this embodiment, the remote device can request a list of all jukeboxes 10a, 10b, 10c from data center 20 and/or the second central server. Using remote device 50, a user can enter a selection of a particular jukebox 10 on which the user wishes to have a song played. Once a jukebox 10 is selected, the data center 20 may send a listing of the songs available for play on the selected jukebox 10.

In accordance with another preferred embodiment, the user has a listing of unique identifiers which identifies particular songs available for play at a particular location. For example, at a jukebox 10a, a song list displayed may include a list of unique identifiers that can be entered by remote devices 50 and used to identify a song or a series of songs for play on jukebox 10a. In one embodiment, the unique identifier contains at least two pieces of identifying information: a code representing the location of the selected jukebox and a code representing the particular song selected for play. For instance, the unique identifier may be in the form of a six-digit number, where the first three digits represent a code for the locations, and the second three digits represent a particular song that can be played at that jukebox. The data center 20 can interpret the entered identifier to determine the user's specific request to play a selected song or series of songs.

In accordance with another embodiment, the remote device 50 is associated with a particular jukebox 10, such that only a code representing the song selection needs to be entered. For example, a jukebox may be integrated with a game machine, that acts as a remote device 50, allowing users to make song selections for the associated jukebox 10 without being physically at the jukebox. In that scenario, a user would only need to enter a code representing the song selection, as the data center 20 would interpret the selection as being for the jukebox 10 associated therewith.

In either of the described embodiments, the user enters at least one song selection at step 203. It should be understood that the system 100 can process multiple requests at once from one or more remote device(s) 50.

Next, at step 204, the data center 20 may send a request to remote device 50 regarding the priority status of the selection (i.e., whether the selection should be prioritized, rather than being played in its normal received sequence). In one embodiment jukeboxes 10a, 10b, 10c of system 100 are capable of having one song in a priority position at a time. In this embodiment, the data center 20 must first check a priority queue at the selected jukebox 10 to make sure that this option is available to the remote device 50 user. In another embodiment, the jukeboxes 10a, 10b, 10c may have an entire queue for priority play requests, such that a several priority songs may be played out of the queue before songs are played out of the normal song queue.

In addition, the priority feature can be used to select a particular time for play. For example, a user may wish to have a particular selection played on a jukebox at a pre-determined time. Thus, the priority feature may include functionality to allow a user to enter a particular time for play.

In a preferred embodiment of the invention, priority play songs cost a user more money than a “normal” selection. Accordingly, at step 205, if a user indicates that a priority play is desired, the data center 20 sends a message to the remote device 50 indicating the increased price of the priority play feature. At this point, (step 206), the user may either accept or decline the additional payment.

At step 207, the selection of one song is complete, and the data center 20 will ask the remote device 50 user whether or not the user has further requests at this time. If so, the user is looped back up to step 202, if necessary, where a list of the jukeboxes 10a, 10b, 10c and the available music is presented to the user or to step 203 where the user can enter further requests. If the user does not have any further requests at step 207, the method proceeds to the next step.

Next, some method of payment may need to be handled for the remote song selection. The payment can be initiated by the data center 20 or the secondary central servers 30. For example, at step 208, the user of a remote device 50 may be prompted to enter credit card information for billing the song selections. Alternatively, the remote device 50 may include a payment means such as a coin/bill acceptor, such that the remote device 50 may accept payment directly for the requests. In addition, payment at this step may altogether may be unnecessary if the remote device 50 previously established a method for payment.

At step 209, the request is communicated from the data center 20 to the selected jukebox 10. If the requested song is one that is not available in local storage 11 at the jukebox, the song file may also be sent from the data center. Information on the type of play, priority or normal, is also communicated to the jukebox 10. It should be understood that the data center 20 can perform numerous other functions while the method 200 is being carried out. For example, normal management functions such as song downloads, royalty calculations, data requests, etc. are being simultaneously performed. In addition, the data center 20 may also be receiving data from the jukeboxes 10a, 10b, 10c and/or be receiving data and requests from operator devices 60.

In accordance with an embodiment of the present invention, remote song selection at a jukebox 10 is performed by sending messages between the remote device 50, and a messaging server that acts as the second server 30.

In another embodiment, the data center 20 requires a unique identifier for each jukebox 10a, 10b, 10c. and a unique identifier for each song that can be requested. The Ethernet MAC address can be used as the jukebox 10 identifier. A unique message transaction identifier is included in all HTTP messages from the messaging server to allow the data center 20 to support multiple song requests simultaneously. A load balancer can be utilized at the data center 20 if the messaging traffic is heavy.

The messaging server 30 can issue HTTP “GET” and “POST” messages to the data center 20. GET messages are used when data is requested from the data center 20, and POST messages are used when useful data is being sent to the data center 20. The data center 20 responds to each of these messages-either by supplying requested data or by an acknowledgement. The data center 20 will send a POST message to the messaging server 30 when status of a play request is available from a target jukebox 10.

Original messages can be initiated by the messaging server 30 and include a unique transaction number for each set of messages. For example, the messaging server can request a document from the data center 20 containing a list of the networked jukeboxes 10a, 10b, 10c and a list of the music content that resides at the data center 20 in the central memory 20b. Based upon a selection transmitted from the remote device 50 to the messaging server, a request is sent from the messaging server 30 to the data center 20 identifying a particular jukebox 10 and a particular musical selection to play. The request may also include timing information, and is marked as either a “normal” or “priority” selection.

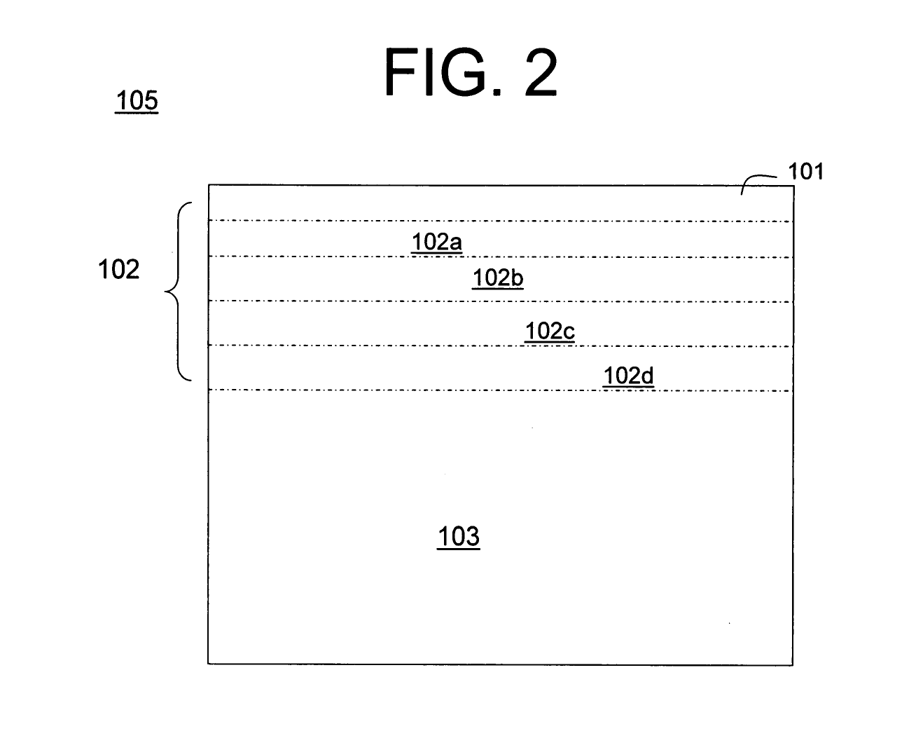

With reference to FIG. 2, the structure of an exemplary HTTP message 105 that may be exchanged between the messaging server 30 and the data center 20 is depicted. The first line 101 of the message 105 contains the request verb (either GET or POST) or the status code returned by the data center 20. This line 101 is not considered part of the normal HTTP header. It is transparently constructed and processed by WinInet functions. Other lines of the HTTP header 102 must be explicitly specified by the application program. All header lines 102a, 102b, 102c, 102d are standard header lines, shown as containing information such as content type or content-length. The exemplary message structure 100 is shown as having four lines of ASCII header text 102a, 102b, 102c, 102d.

The first line 102a is the Content-Type field, which preferably is included in all message headers 102. The Content-Type filed indicates the type of message being sent. The line 102a also includes the unique-label field. The unique-label field is generated by the messaging server 30 and is used to track the status of the message command that has included the unique label. When the data center 20 reports an error or successful completion of an action, the unique label will be included in the report. In an exemplary embodiment, the format of the unique-label field is a dash-delimited string made up of the messaging server's 30 MAC address and the current data and time (without delimiters).

The second line 102b of the header 102 is the Content-Encoding field. This line 102b is used whenever the body 103 of the message 105 is not empty. It shows the encoding scheme for the content in the message body 103.

The third line 102c of the header 102 is the Content-Length field. The Content-Length line 102c specifies the length of the message body 103, preferably in bytes. The receiver of the message 105 can use this information to allocate resources for storing and processing the message body 103, or as an additional check on the message body 103 integrity.

The fourth and final exemplary line 102d of the header is the Accept field. This line 102d is used only in requests sent from the messaging server 30 to inform the data center 20 about the response types that the messaging server 30 will accept.

The body 103 of the message 105 contains the effective information. The information may be XML formatted data or just plain strings. For some messages, the body 103 of the message 105 is empty. In other messages 105 sent from the data center 102, the body 103 contains an URL. In response to receiving such a message, the next step is for the messaging server to download the file located at the URL. This should proceed without any interaction from the application program (Java servlet) on the data center 20. A restartable protocol is used, thus if the connection breaks during the download, a retry is attempted and the download continues from the point where it was broken.

Some request messages sent by the messaging server 30 require the data center 20 to respond with content in the body 103 of the HTTP messages 105. In another embodiment, there are four other categories of responses that the data center 20 may send. Two of the four are actual responses generated by the data center application: Server ACK and Server Error. The other two represent problems with the HTTP protocol itself: HTTP Error and a timeout. The messaging server 30 is capable, in the event that an HTTP generated Error or timeout occur, to log this event along with other information to help identify the cause of the error. These errors should not cause the messaging server to lock up, get stuck in a loop, or otherwise fail to continue normal operation.

Other request messages sent by the messaging server require only a confirmation response (ACK) from the data center 20. The confirmation message guarantees that the data center 20 has successfully processed the message content with an ACID transaction.

A request message sent by the data center 20 may cause the messaging server to respond with an error. The error may be caused by badly formed XML text, or unknown or bad data in the body 103 of the message 105. In the event that a server error occurs, the server application responds with a Server_Error message. In the body of a Server_Error message, information to help identify the cause of the error should be included.

During exemplary normal operation of the system 100, the messaging server 30 sends numerous types of requests to the data center 20. These requests include requesting jukebox lists, song lists, playback of a song, and play status. The first two of these requests (jukebox and song lists) are GET messages, asking the data center 20 for particular information. In response, the data center 20 will send a URL in the body of a message. The URL points to the data file that contains the information being requested. The jukebox and song lists may be XML files stored on a server, such as memory server 20b, at the data center 20. The song list file may be unique for each of the jukeboxes 10a, 10b, 10c on the network or it may be one file containing a list of each song stored in the central memory 20b.

The latter two types of requests (play and play status) are POST messages. The song playback request is sent by the messaging server 30 in response to a user's input on a remote device 50. The request will include the unique song identifier and a jukebox identifier. Other information, such as type of request (priority or normal), time for playback, and billing information may also be included in this message. A play status message may be sent to the data server whenever a play request has not been closed. Information in the message includes the unique transaction identifier of the transaction for which status data is being requested. The data center 20 responds with the status of the transaction.

Once the data center 20 has received a song playback request for a particular jukebox 10, that request needs to be communicated to the jukebox 10. This may be done through any type of messaging function. In addition, the server may have pending messages that are stored on the server, and that a jukebox 10 receives when it checks into the server during periodic check-ins. The song can be played back on the jukebox using any suitable playback mechanism (e.g., hardware MP3 player using a dedicated decoder chip, hardware MP3 player using a Digital Signal Processor (DSP), a software codec running on the jukebox processor.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Additionally, any modifications, though presently unforeseeable, of the present invention that come within the spirit and scope of the following claims should be considered part of the present invention.

What is claimed as new and desired to be protected by Letters Patent of the United States is:

1. A method of remotely selecting a song for play on a computer jukebox, the method comprising:
providing a first data center coupled to a network comprising a plurality of computer jukeboxes;
establishing a communications link between a remote device and the data center;
sending a first message from the remote device to the data center, wherein the first message comprises: a selection of a computer jukebox on which the user of the remote device desires a song to be played and a selection of a song that the user of the remote device desires to be played on the computer jukebox;
transmitting a second message from the data center to the selected jukebox wherein the second message comprises a command for the jukebox to play the selected song; and
playing the selected song at the selected jukebox in response to receiving the second message.

2. The method of claim 1, wherein the remote device is selected from the group consisting of a telephone, a PDA, a personal computer, a Bluetooth device, a digital camera, an MP3 player, and a digital game machine.

3. The method of claim 2, wherein the second message comprises an http message, said http message including an identification of the song selected for play.

4. The method of claim 3, wherein the second message further comprises identifying the time when the selected song is to play at the computer jukebox.

5. The method of claim 1, further comprising transmitting a list of songs available at a particular one of the plurality of computer jukeboxes to the remote device from the first data center.

6. The method of claim 1, further comprising sending information on the pricing of selections to the remote device from the first data center.

7. The method of claim 6, wherein the pricing of selections includes a base price for selecting a particular song and an increased price for selecting a particular song for priority play.

8. The method of claim 1, further comprising managing the remote device with a second data center used for managing the remote device, and wherein the second data center communicates directly with the first data center.

9. The method of claim 1, further comprising determining whether a position is available in a queue of the selected jukebox for a priority selection.

10. The method of claim 1, further comprising the act of sending a third message from the data center to the remote device, wherein the third message comprises at least one of: a jukebox listing and a song listing for a particular jukebox.

11. A system for the remote selection of a song on a computer jukebox, the system comprising:
a first data center comprising at least one server for managing a plurality of jukeboxes;
each of the plurality of computer jukeboxes including:
a memory for storing a plurality of digital songs;
a playback mechanism for playing the plurality of digital songs; and
a communication interface for sending and receiving messages from the first data center; and
at least one remote device capable of sending messages to the first data center, the messages comprising requests for musical selections for a particular jukebox, and in response to receiving one of said messages, said first data center generates a command for a selected jukebox.

12. The system of claim 11, further comprising a second data center for managing a plurality of the remote devices, wherein the second data center receives the selection information and transmits the selection information to the first data center.

13. The system of claim 11, wherein the remote device is one of a telephone, a cellular device, a Bluetooth device, a PDA, a personal computer, a digital camera, an MP3 player, and a digital game machine.

14. The system of claim 11, wherein the command generated by the first data center includes information on a time a selected song is to be played at the jukebox.

15. The system of claim 11, wherein the first data center includes a computer memory for storing a plurality of musical selections, and wherein a musical selection can be transmitted to a particular jukebox in response to receiving said request by said remote device.
